(19) United States
(12) Patent Application Publication
(10) Pub. No.: US 2019/0312905 A1
(43) Pub. Date: Oct. 10, 2019

(54) SYSTEMS AND METHODS FOR ASSESSING THE STATUS AND SECURITY OF ELECTRONIC NETWORK SERVERS AND SYSTEMS

(71) Applicant: Corporate Knowledge, LLC, Pensacola, FL (US)

(72) Inventors: Dwayne GREEN, Thibodaux, LA (US); Holly SMITH, Pensacola, FL (US); Hazel WIGGINGTON, Pensacola, FL (US)

(73) Assignee: Corporate Knowledge, LLC

(21) Appl. No.: 16/376,292

(22) Filed: Apr. 5, 2019

Related U.S. Application Data
(60) Provisional application No. 62/653,954, filed on Apr. 6, 2018.

(51) Int. Cl. H04L 29/06

(52) U.S. Cl. CPC H04L 63/1433; H04L 63/205

(57) ABSTRACT

Systems and methods are disclosed for determining a secured system security risk score. One method comprises receiving, on an electronic network, security data corresponding to a security vulnerability of each of a plurality of servers, each of the plurality of servers being associated with a secured system. A server security risk score may be determined for each of the plurality of servers, based on the security data corresponding to the security risks for each of the plurality of servers. The server security risk score may be modified, for each of the plurality of servers, based on a time elapsed since a discovery of each security vulnerability or hosting environment influence. A secured system security risk score may be determined, associated with the secured system, based on the mitigated server security risk score for each of the plurality of servers.

### CROSS-REFERENCE TO RELATED APPLICATIONS

This application claims priority under 35 U.S.C. § 119(e) to U.S. Provisional Application No. 62/653,954, filed on Apr. 6, 2018, entitled “SYSTEMS AND METHODS FOR ASSESSING THE STATUS AND SECURITY OF ELECTRONIC NETWORK SERVERS AND SYSTEMS,” and the contents of the foregoing applications are incorporated herein by reference in their entireties.

### TECHNICAL FIELD

Various embodiments of the present disclosure relate generally to assessing the risk status and security of electronic network servers, devices, and systems. More specifically, particular embodiments of the present disclosure relate to systems and methods for timely risk assessment, prioritization, escalation and/or resolution of detected security vulnerabilities.

### BACKGROUND

Vulnerability detection software solutions for electronic systems exist, but the results can be difficult to interpret, as the solutions may provide many differing and incompatible metrics of system security risk. Further, once security vulnerabilities are identified, they may languish unresolved or unmitigated indefinitely. A server, device, system, environment, etc., may receive a certain security rating, but it may be unclear how a newly detected vulnerability should affect that rating. Solutions are needed to resolve these issues.

### SUMMARY OF THE DISCLOSURE

According to certain embodiments, systems and methods are disclosed for determining a secured system security risk score. One method comprises receiving, on an electronic network, security data corresponding to a security vulnerability of each of a plurality of servers, each of the plurality of servers being associated with a secured system. A server security risk score may be determined for each of the plurality of servers, based on the security data corresponding to the security vulnerability for each of the plurality of servers. The server security risk score may be modified, for each of the plurality of servers, based on a time elapsed since a discovery of each security vulnerability. A secured system security risk score may be determined, associated with the secured system, based on the server security risk score for each of the plurality of servers.

According to certain embodiments, systems are disclosed for determining a secured system security risk score. Instructions, when executed, may cause the system to execute a method comprising receiving, on an electronic network, security data corresponding to a security risk of each of a plurality of servers, each of the plurality of servers being associated with a secured system. A server security risk score may be determined for each of the plurality of servers, based on the security data corresponding to the security risk for each of the plurality of servers. The server security risk score may be modified, for each of the plurality of servers, based on a time elapsed since a discovery of each security risk. A secured system security risk score may be determined, associated with the secured system, based on the server security risk score for each of the plurality of servers.

According to certain embodiments, a non-transitory computer readable medium is disclosed comprising instructions for determining a secured system security risk score. The instructions may cause the system to execute a method comprising receiving, on an electronic network, security data corresponding to a security risk of each of a plurality of servers, each of the plurality of servers being associated with a secured system. A server security risk score may be determined for each of the plurality of servers, based on the security data corresponding to the security risk for each of the plurality of servers. The server security risk score may be modified, for each of the plurality of servers, based on a time elapsed since a discovery of each security risk. A secured system security risk score may be determined, associated with the secured system, based on the server security risk score for each of the plurality of servers.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is an example diagram of a risk management framework, according to embodiments of the present disclosure;

FIG. 2 is an example diagram of a method of amassing server risk, according to embodiments of the present disclosure;

FIG. 3 is an example diagram of a mitigated hosting environment, according to embodiments of the present disclosure;

FIG. 4 is an example diagram of a method of applying a mitigating host environments to server basic risk level, according to embodiments of the present disclosure;

FIG. 5 is an example diagram of a method of migrating from a remediation priority to a mitigated remediation level remediation priority, according to embodiments of the present disclosure;

FIG. 6 is an example diagram of a setting input and review compliance threshold settings for data source feeds and information documentation, according to embodiments of the present disclosure;

FIG. 7 is an example diagram of tracking input and review compliance of a server, according to embodiments of the present disclosure;

FIG. 8 is an example diagram of the process of obtaining a mitigated risk level utilizing input and review thresholds according to embodiments of the present disclosure;

FIG. 9 is an example diagram of risk escalation levels and thresholds according to embodiments of the present disclosure;

FIG. 10 is an example diagram of the process of escalating an active vulnerability according to embodiments of the present disclosure;

FIG. 11 is an example diagram of security impact by system according to embodiments of the present disclosure;

FIG. 12 is an example diagram of security impact on remediation action list of systems according to embodiments of the present disclosure;

FIG. 13 is an example diagram of details of remediation priority of systems by security impact according to embodiments of the present disclosure;

FIG. 14 is an example diagram of the aggregation of servers to organization hierarchy, according to embodiments of the present disclosure;

FIG. 15 is an example diagram of the aggregation of servers to organization hierarchy according to embodiments of the present disclosure;

FIG. 16 is an example diagram of the aggregation of servers to organization hierarchy, according to embodiments of the present disclosure;

FIG. 17 is an example diagram of the aggregation of servers to organization hierarchy, according to embodiments of the present disclosure;

FIG. 18 is an example diagram of the aggregation of servers to organization hierarchy, according to embodiments of the present disclosure;

FIG. 19 is an example diagram of the aggregation of servers to organization hierarchy, according to embodiments of the present disclosure;

FIG. 20 depicts risk normalization techniques, according to embodiments of the present disclosure;

FIG. 21 is a listing of formulas that may be used to determine metrics discussed herein;

FIG. 22 is a flow diagram of a methods for determining system risk, according to embodiments of the present disclosure; and

FIG. 23 is a simplified functional block diagram of a computer that may be configured as a client, agent, or server for executing the method of FIG. 22, and other techniques discussed herein, according to exemplary an embodiment of the present disclosure.

### DESCRIPTION OF THE EMBODIMENTS

Reference will now be made in detail to the exemplary embodiments of the disclosure, examples of which are illustrated in the accompanying drawings. Wherever possible, the same reference numbers will be used throughout the drawings to refer to the same or like parts.

Systems and methods presented herein may detect and categorize security vulnerabilities, and modify the assessed risk level of data sources, servers, Internet of Things (IoT) devices, systems, etc., based on the categorization. The assessed risk level may further be modified over time based upon predetermined rules, such as the time since discovery, and mitigation steps taken.

In particular, techniques presented herein may receive a plurality of security ratings from different data sources, which may be normalized to a single security rating standard. The security ratings may be received from a plurality of data sources, and may evaluate the security risk of data sources, servers, IoT devices, systems, networks, environments, other devices, etc. The determined security ratings may be increased or decreased based upon predetermined multipliers. For example, if a predetermined time period has elapsed since the discovery of a security risk, the security risk rating may be increased by a predetermined multiplier or category. Security risk ratings may also be based upon risk ratings of elements lower or higher in the electronic system hierarchy for a given organization. The security ratings may further be continually reassessed, allowing for iterative re-assessment of security risk status and/or accreditation.

Security impacts for data sources, servers, systems, networks, environments, devices, etc., may also be determined. A user may be able to prioritize, based on predetermined rules, the resolution of security risks not only based on the risk level, but also based on the assessed impact.

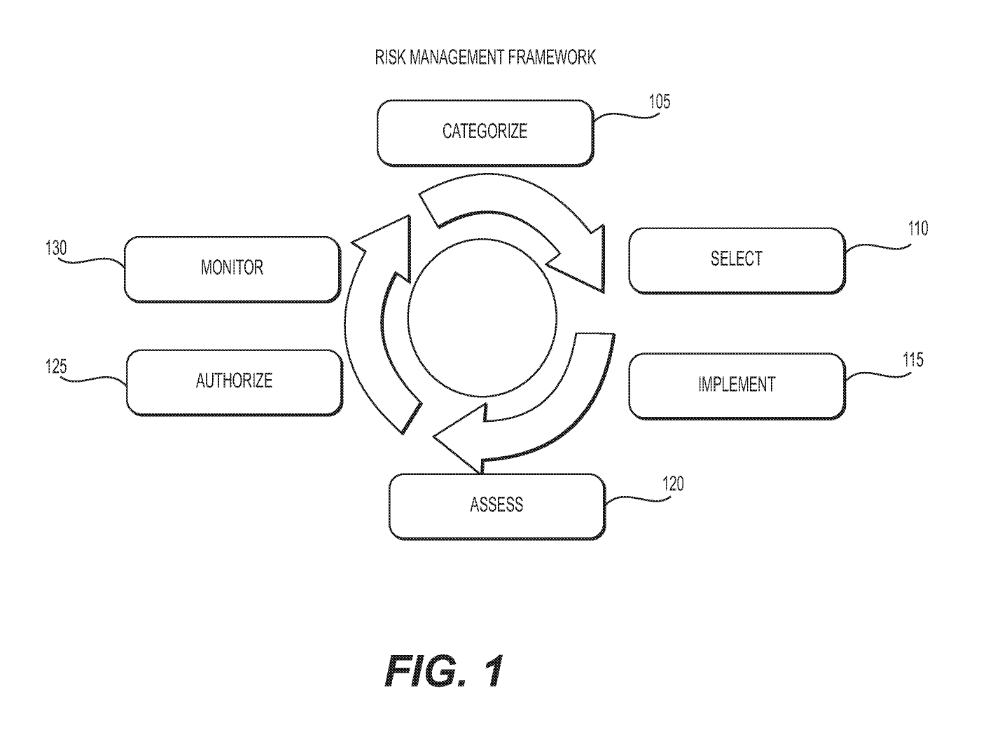

FIG. 1 depicts an example risk management framework, which may be implemented in accordance with techniques presented herein. The risk management framework may be driven by six phases, which may be lock-stepped. Step 105 may comprise categorizing electronic information systems in an organization, the organization comprising a group, company, firm, corporation, office, consortium, conglomerate, agency, government, armed service, etc. First, a system boundary may be defined, and the types of information utilized by the system may be defined. Information may be gathered about the system's operating environment, intended uses, and/or connections with other systems that may affect the security of the system. Step 105 may be driven by Committee on National Security Systems (CNSS) Instruction No. 1253, and/or National Institute of Standards and Technology (NIST) Special Publication (SP) 800-60.

At step 110, security controls may be selected. Security controls are the various safeguards that may be implemented within an organization, which may include managerial, operational, and/or technical safeguards. Step 110 may be driven by NIST SP 800-53 and/or CNSSI 1253, for example.

At step 115, security controls may be implemented. It may be determined and described how to deploy safeguards for each device, each system, each server, each group of systems, etc., within the organization. Step 115 may be driven by NIST SP 800-37 and/or NIST SP 800-70, for example.

At step 120, security controls may be assessed. Procedures may be executed to determine that security controls are or will be implemented correctly, operating as intended, and producing the desired outcome with respect to the security requirements of the system. Step 120 may be driven by NIST SP 800-53A and/or NIST SP 800-37, for example.

At step 125, the information system may be authorized based on a determination of the risks to the operation of the organization, organization individuals or assets, other organizations, and/or national or transnational system. Any failed controls may be tracked, and the status may be monitored and reported. Step 125 may be driven by NIST SP 800-39, NIST SP 800-37, and/or NIST SP 800-30.

At step 130, the information system may be continuously monitored for changing threats and vulnerabilities given changing business processes and technologies. Automated tools may be employed to provide near real-time risk management. Step 130 may be driven by NIST SP 800-53A, NIST SP 800-137, and/or NIST SP 800-30, for example.

The risk management framework enables organizations to systematically focus on securing their electronic environment, and allows for a more objective system for assessing system security than prior techniques.

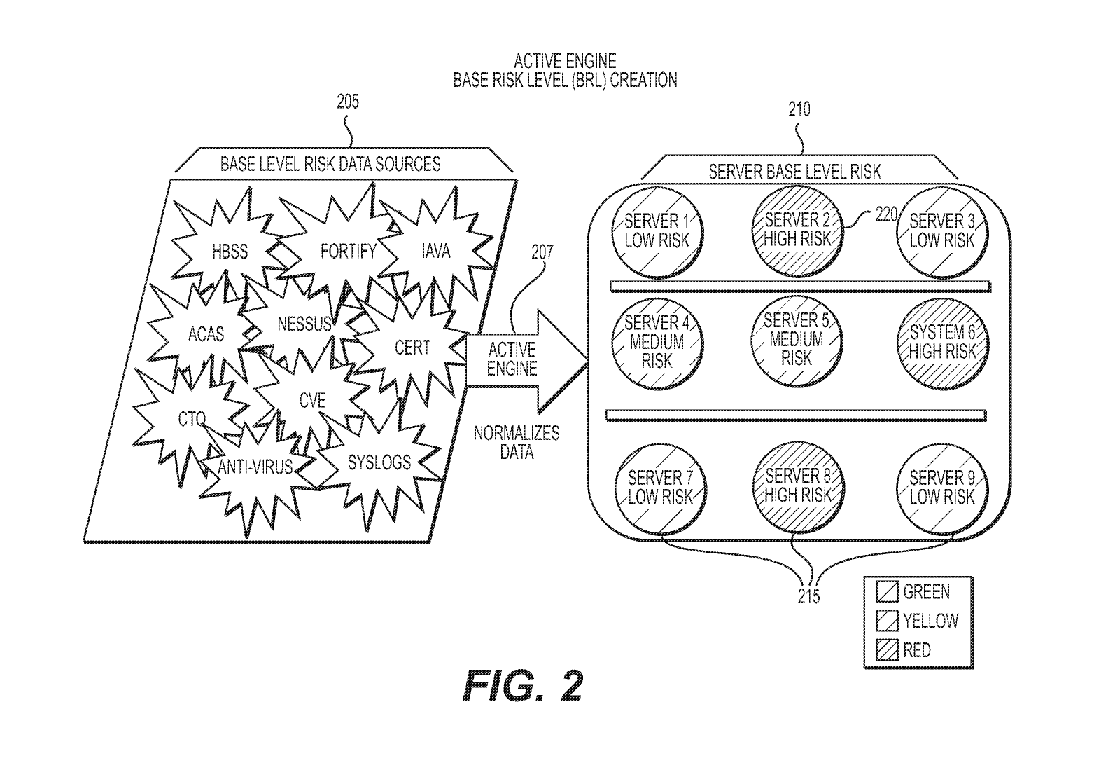

The diagram in FIG. 2 depicts example data sources 205, which may comprise one or more servers connected to an electronic network, of an organization. The data sources 205 may provide data derived by the analysis of security information 205 at the server level for each server, for example, by IP address. Each data source 205 may be processed by the Active Engine 207, which may normalize the data, as will be discussed elsewhere herein. Each data source 205, for example, Assured Compliance Assessment Solution (ACAS) scan results, may be analyzed to establish security risk status. The risk level of each server in the cluster/hierarchy of servers 210 may be evaluated independently, as will be discussed further herein. Once a base level of risk is determined for servers 215, this base level may be modified based on a variety of factors, as will be discussed further herein.

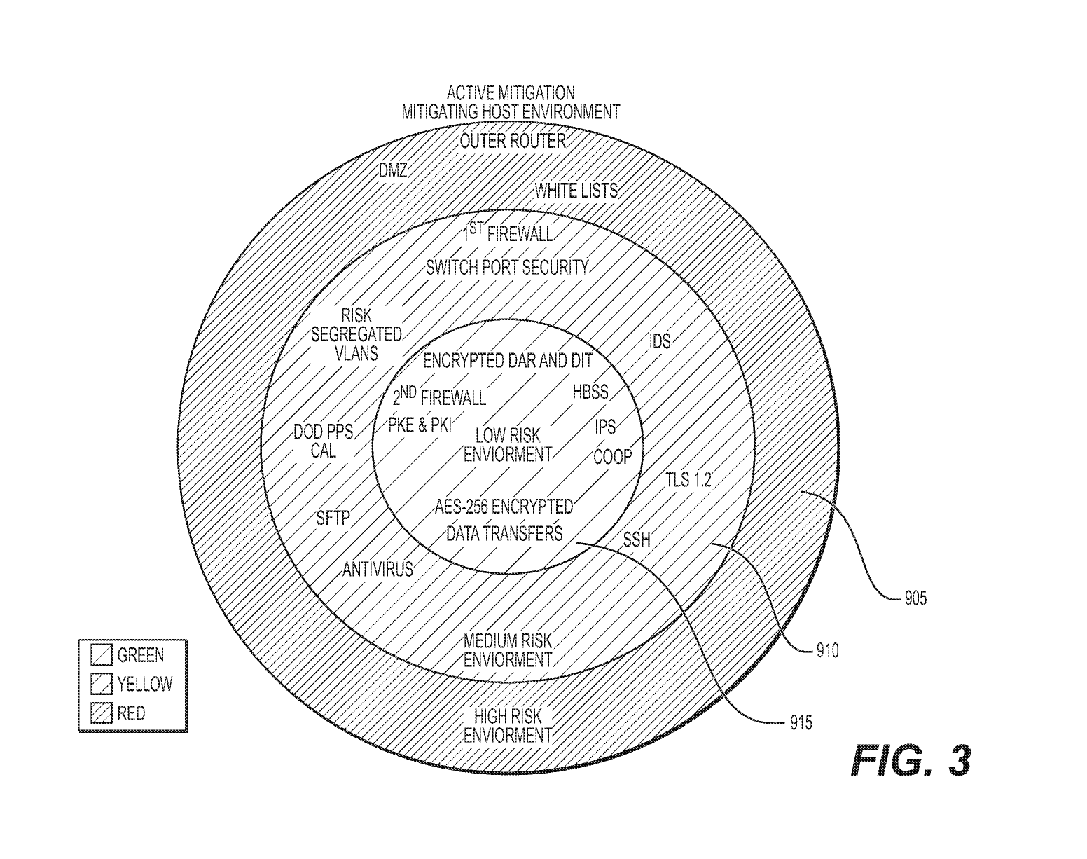

As shown in FIG. 3, mitigation steps may be taken based on risks and impacts that may have been identified. Mitigation may be applied at the server level since it may be a result of the environment where the server resides and the protection system installed on the server. The mitigation environment may reflect varying levels of network, server, and data protection. For example, a high-risk environment 905 may be protected by a few risk mitigating components such as white lists or a demilitarized zone/perimeter network. A server may obtain a medium mitigated risk by being associated with a medium-risk environment 910, which may add additional mitigating components such as putting the server behind a first firewall, exposing it to antivirus protection, etc. These support and protection structures may be layered to protect the server and/or system and mitigate the base risk. For example, all protections of the high-risk environment 905 may automatically be present in the medium and low-risk environments 910 and 915. Mitigation data may be inputted by an authorized user(s). By adding additional predetermined mitigating measures, a server's security risk may be improved substantially by environmental protections.

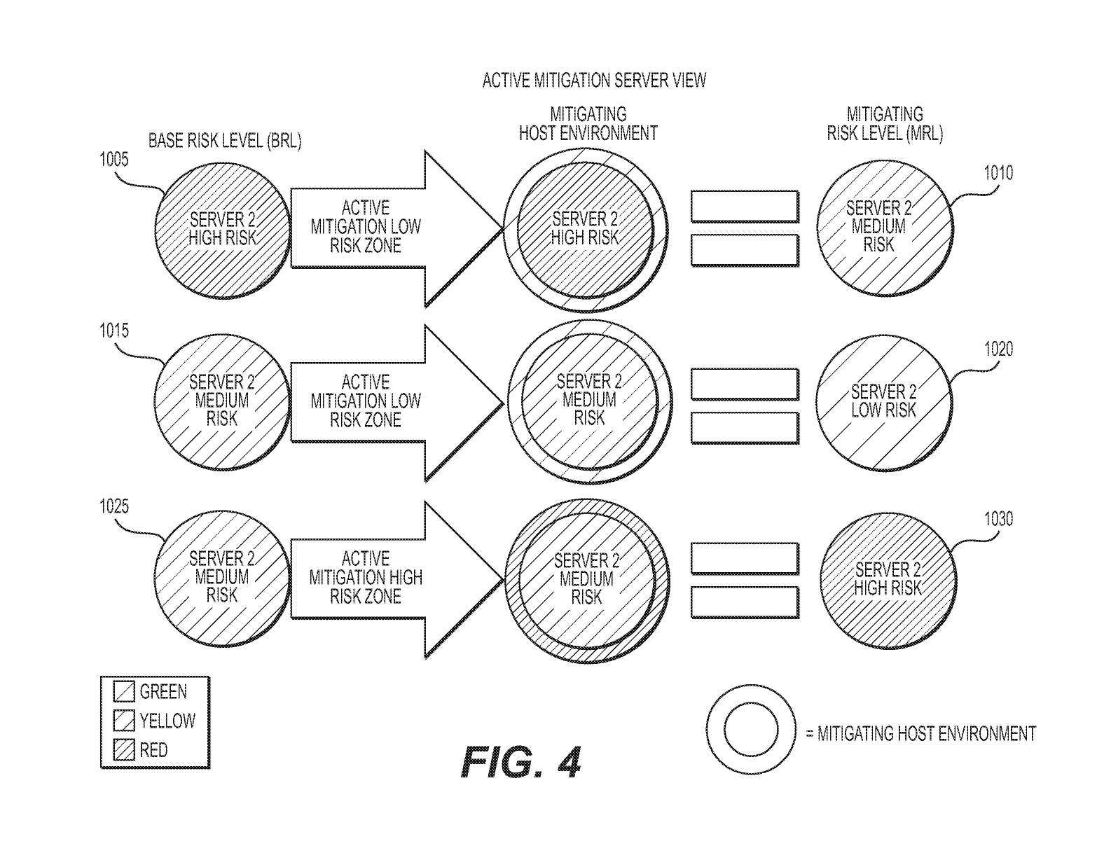

As shown in FIG. 4, an individual server 1005 that is high risk may receive active mitigation in a low-risk environment 915, and may subsequently be downgraded to medium risk 1010. Similarly, a medium-risk server 1015 may receive active mitigation by being placed in a low-risk environment 915, and the server may subsequently be downgraded to a low-risk server 1020. Risk levels of servers may also be upgraded. For example, a medium-risk server 1025 may be moved to a high-risk environment 905, and the server may be upgraded to a high-risk server 1030.

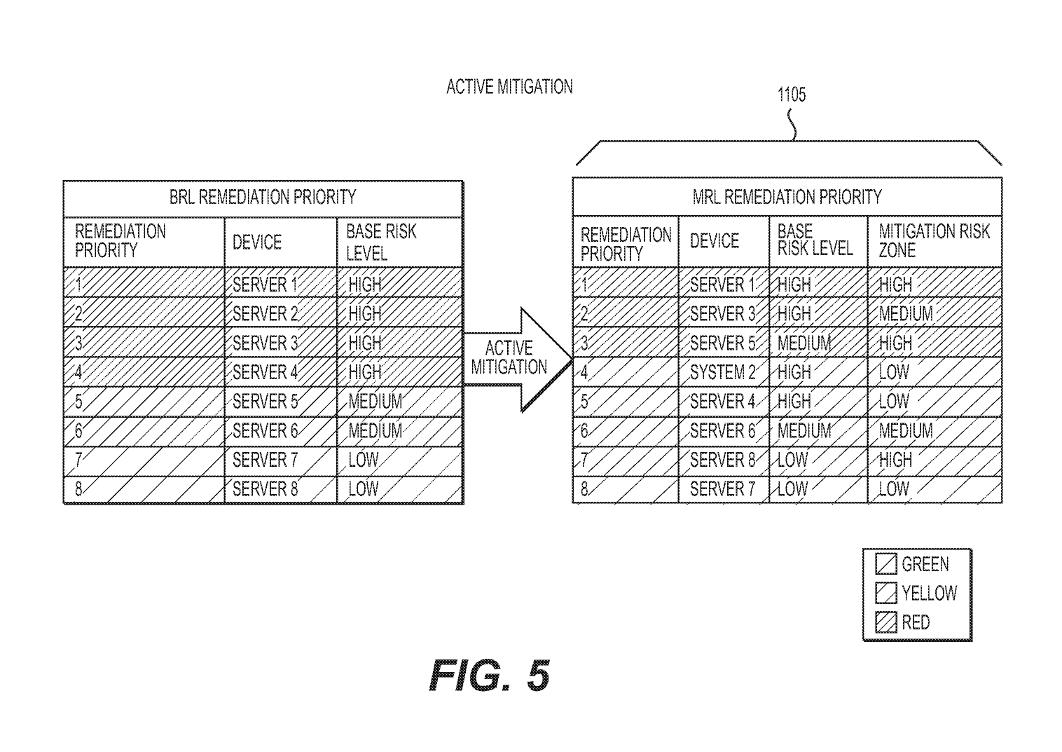

As shown in FIG. 5, at the table 1105, remediation priorities may be changed based upon the resultant mitigation risk zone after active mitigation is applied. For example, after a server with a high-risk level is mitigated by migration to a low-risk environment 915, the server may be considered safer, and be associated with a lower remediation priority. If a low-risk server is placed in a high-risk environment 905, the server may be considered more vulnerable, and be given a higher remediation priority.

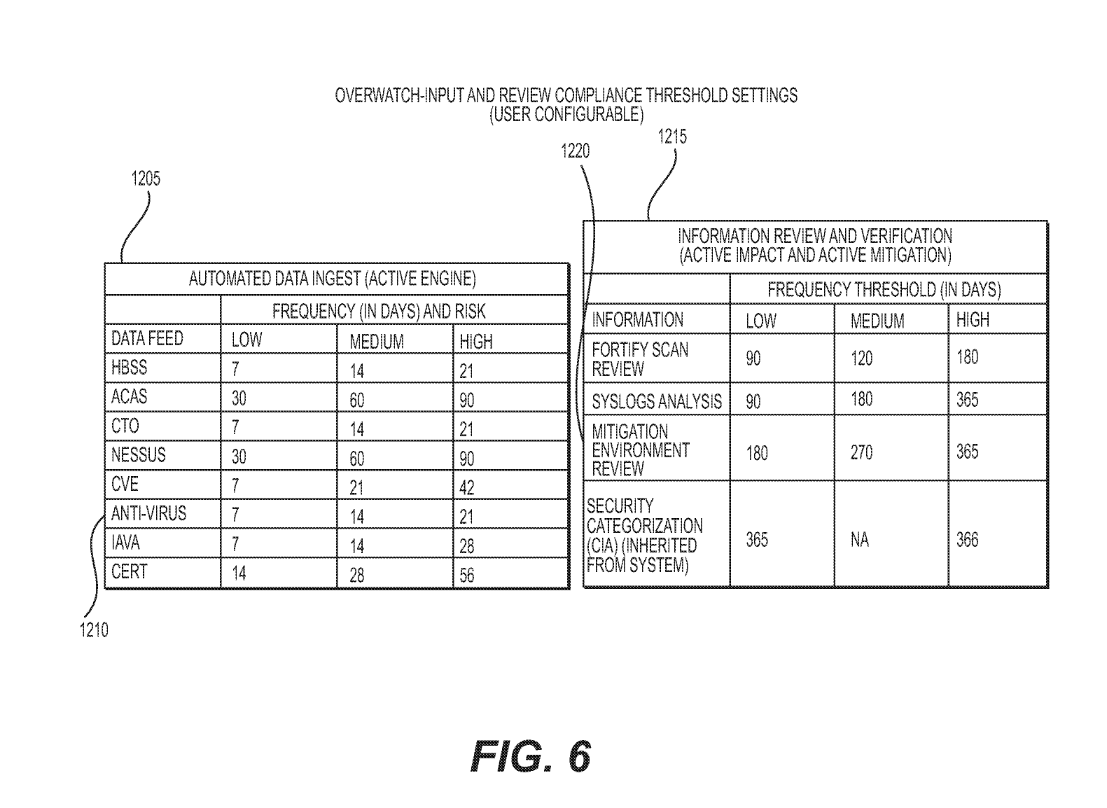

FIG. 6 depicts, in table 1205, example data feeds that may have been identified on a server during the data ingest phase of FIG. 2. An authorized user may be able to configure an amount of time a data feed may need to remain at a given risk level before the risk level is escalated. For example, for the anti-virus data feed 1210, if there is no new data ingested for that data feed, and if the data feed remains at medium risk for 14 days or more, the risk level of the feed may automatically be elevated to high risk. After a predetermined time, the entire system or application, not just the server, may be flagged as higher risk. For example, if the anti-virus data feed 1210 for that server remains at high risk for 21 days or longer, a system that server belongs to may be designated as the next higher risk than currently designated. Similarly, at table 1215, if, for example, the Mitigation Environment Review 1220 remains unreviewed for 270 days, the Mitigation Environment Review 1220 may be escalated to high risk, with that higher risk applied to the server.

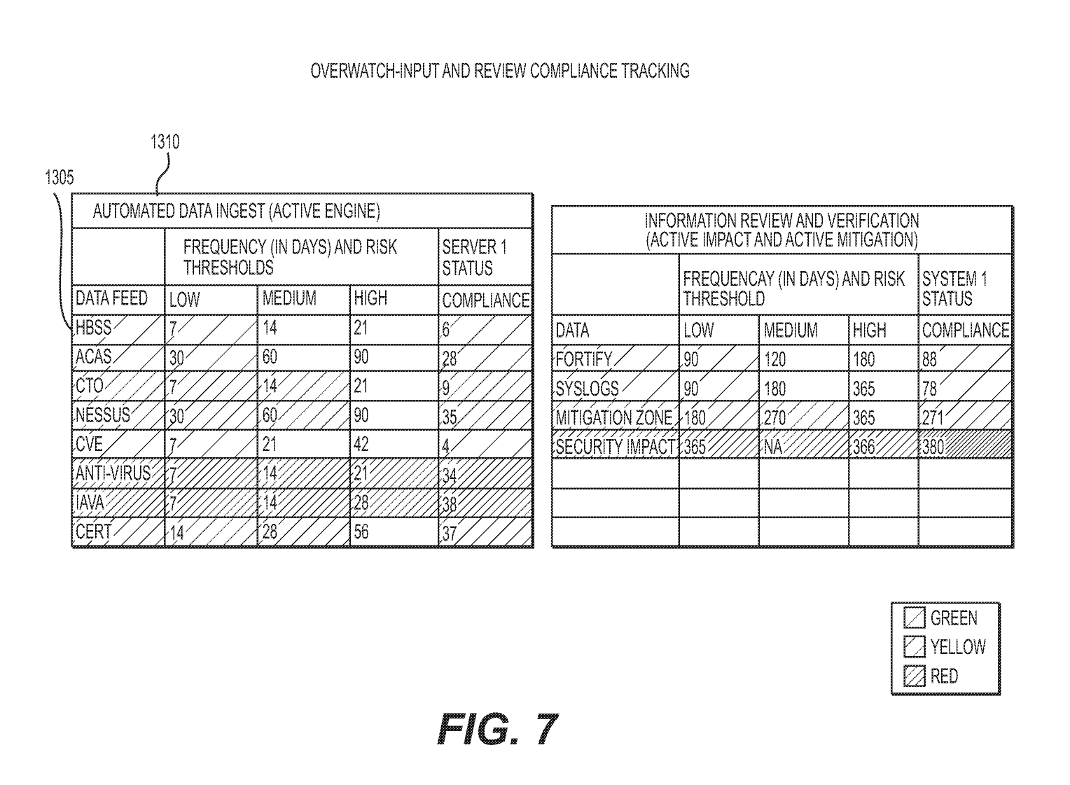

As shown in FIG. 7, day counts for non-compliance may be displayed to the user. For example, for the HBSS data feed 1305 in table 1310, the feed may have been non-compliant for 6 days, meaning that the overall risk level of the data feed is still classified as low since the threshold is seven days.

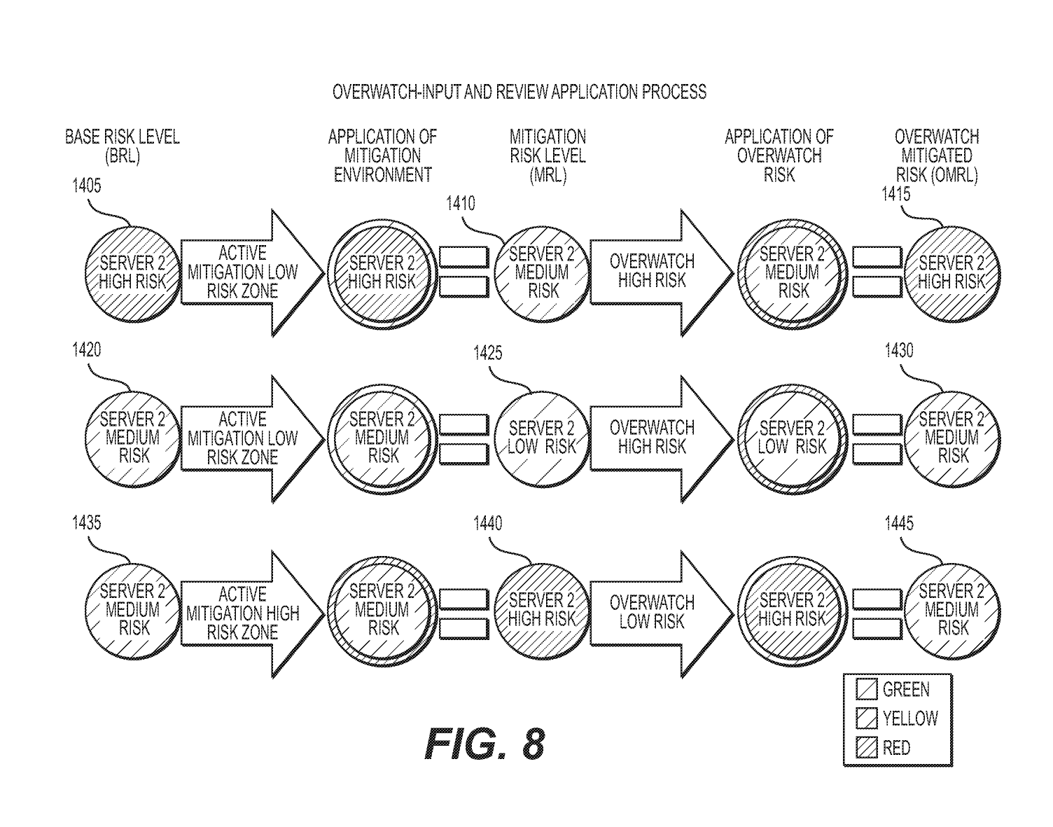

FIG. 8 is a diagram demonstrating the combined application of risk mitigation and OverWatch Input and Review risk factors according to embodiments of the present disclosure. At step 1405, a server designated high risk by Active Engine may receive active mitigation by being associated with a low-risk environment 915, which may cause the server to be re-designated as medium risk at step 1410. With OverWatch Input and Review applied as a high risk, however, the server may be re-designated as high risk at step 1415. Similarly, a server designated as medium risk at step 1420 may be designated as low risk after mitigation by residing in a low-risk environment at step 1425. With OverWatch Input and Review applied as high risk, the server may be re-designated directly from low risk to medium risk at step 1430. A risk designation might also be lowered. A server determined to be medium risk by Active Engine at step 1435 and residing in a high-risk environment becomes a high-risk server at step 1440, but with an OverWatch risk of low, for example, the server may be re-designated as medium risk at step 1445.

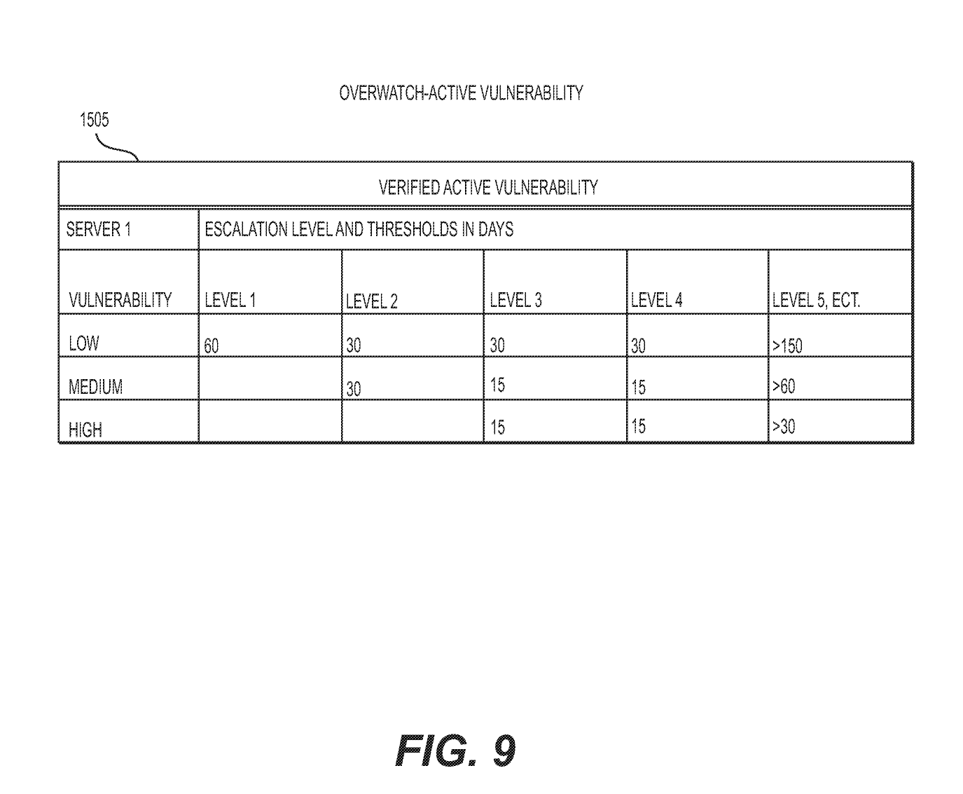

As shown in FIG. 9, vulnerabilities may be identified for a server and/or system, and may be escalated up the hierarchy. Vulnerabilities may be verified using a tool such as Assured Compliance Assessment Solution (ACAS), and may be reported as discussed previously herein. The age of the Active Engine reported vulnerability may be tracked until resolved, and the risk may be escalated over time as required, and as shown in table 1505. Authorized users may be able to configure the values shown in table 1505, such as number of non-remediated or unmitigated days to escalate the risk level from low to medium, medium to high, etc. The number of days to escalate the risk of a server to the system, application, and/or PMO or other higher organizational and/or network level, may also be set by the software and/or by the user.

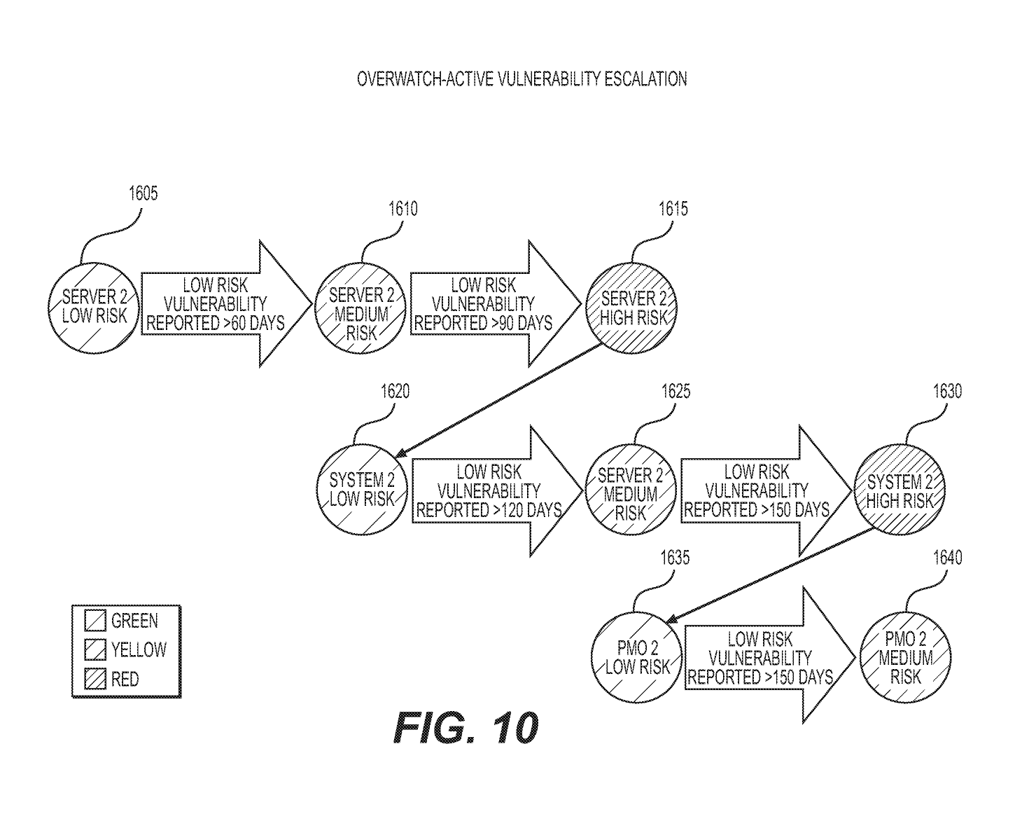

FIG. 10 is a diagram demonstrating how risk escalation may occur according to techniques presented herein. After a low-risk vulnerability has gone unresolved and/or unmitigated for more than, for example, 60 days, a server 1605 may be designated as a medium-risk server 1610. After a predetermined period of, for example, 90 days, the medium-risk server 1610 may be re-designated as high-risk server 1615. After a predetermined period of, for example, 120 days, the system 1620 higher in the organizational/network hierarchy may be re-designated from low risk to medium risk or the next higher risk level 1625. After a predetermined period, the medium-risk system 1625 may be re-designated as a high-risk system 1630. Being designated as high risk may cause the risk level higher up on the organizational hierarchy to be changed, if still not remediated or mitigated within the predetermined period. For example, PMO 1635 may further be designated as a medium-risk PMO 1640 after a predetermined time period of non-remediation. In this manner, after predetermined periods of time, active non-remediated and unmitigated risk vulnerabilities may escalate up the organization, which may help ensure that discovered active vulnerabilities are not forgotten.

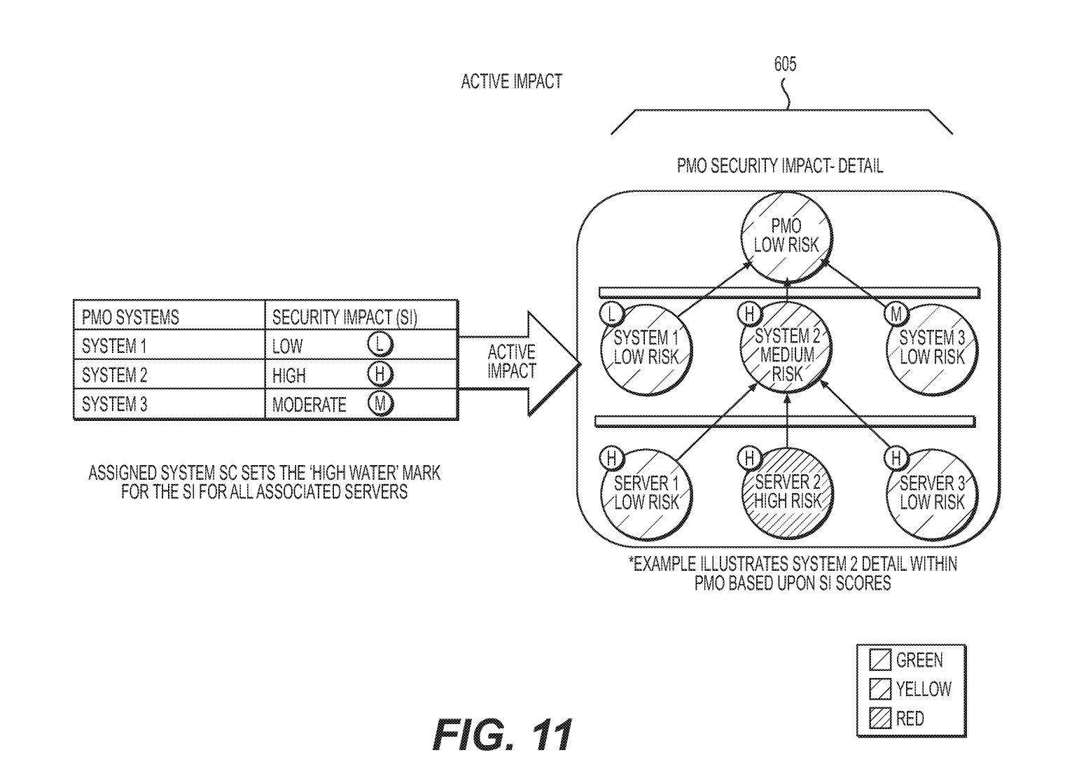

As shown in FIG. 11, the security impact of elements in the electronic environment may also be assessed. The security impact may be evaluated independently of risk level, as relatively unimportant systems may be substantially compromised, and hence labeled high risk, yet the overall threat level to the organization may nonetheless be low. In the example of FIG. 11, three impact levels, e.g., low, medium, and high, may be determined, although a different number of impact levels are possible. Impact may be determined at the system and/or server level. For example, impact may be determined at the system level since it may be an average high water mark of the risk management framework CIA security categorization process. Security impact determined at the system level may be inherited by the one or more servers executing the system.

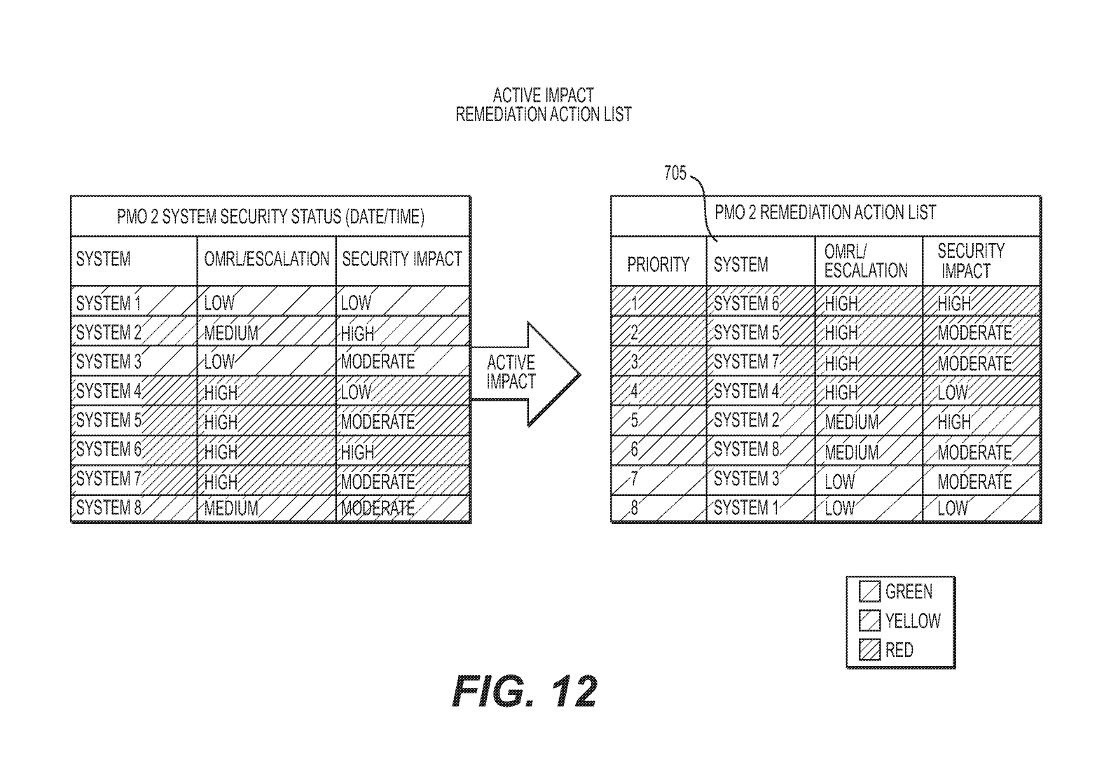

As shown in the diagram of FIG. 12, the remediation priority algorithm may be configurable by a user or organization. For example, a system with a medium-risk level but high security impact may be automatically assigned a higher remediation priority than a system with a high security risk level but a low security impact. Thus, remediation priorities 705 may be set to automatically, and categorically, prioritize higher security impact systems, or set to prioritize higher risk level systems, depending upon user and/or organizational requirements. Remediation priorities 705 may also be set using a more complex combination of risk levels and security impact. For example, security impact may be enabled to trump risk level in remediation priority, or vice versa, but only if the risk levels are off by a maximum predetermined value, such as one level. For instance, a medium-risk level system with a high security impact may be allowed to jump a high-risk level system with a moderate security impact, but a low-risk level system may be prevented from ever jumping a high-risk level system in remediation priority 705, regardless of the associated security impacts.

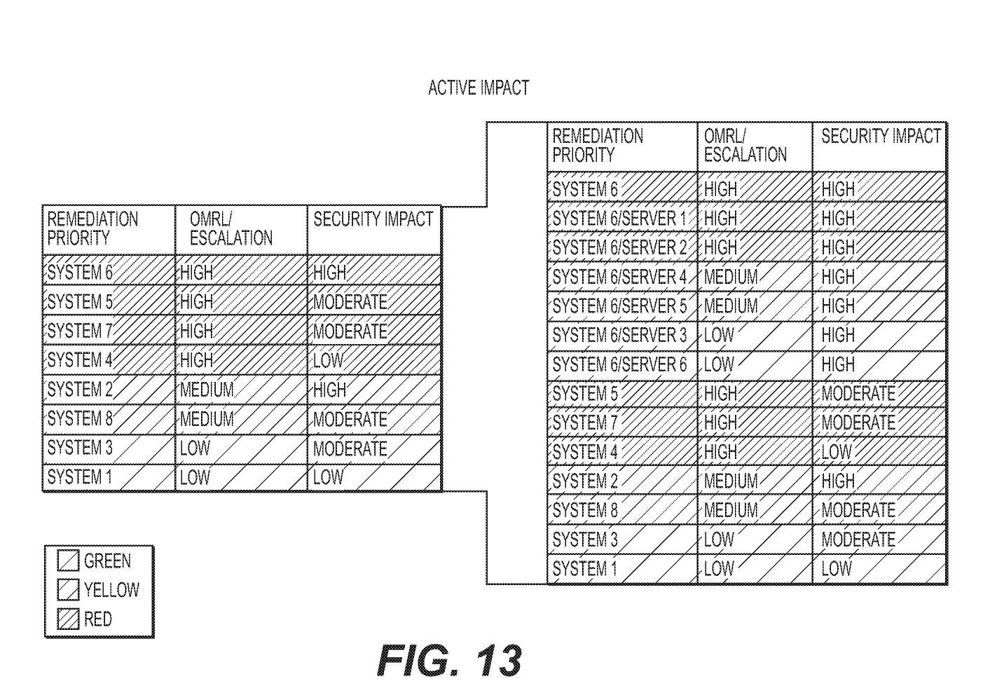

FIG. 13 is a diagram of an expanded view of a remediation priority chart according to embodiments of the present disclosure. A user and/or organization may be able to expand individual systems to view individual servers utilized by each system. As security impact may be assessed at the system level, an identical security impact may be assigned across all servers utilized by a system.

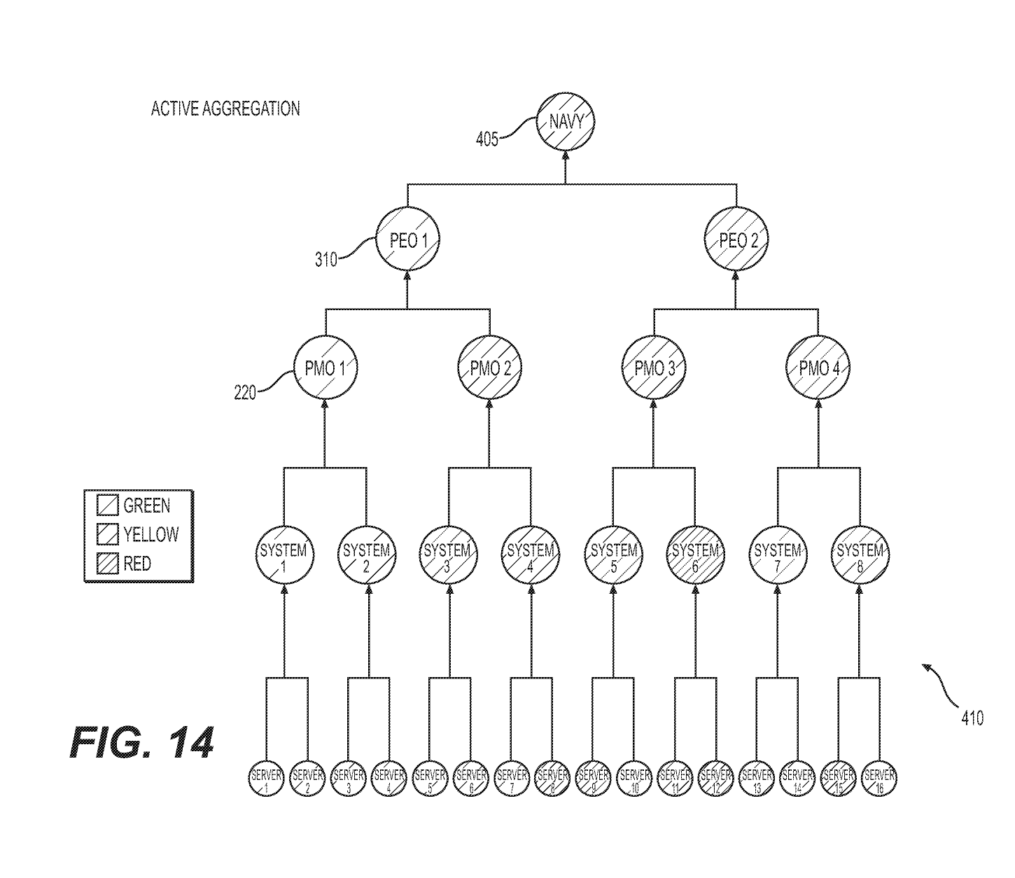

Lower level risk hierarchies may be incorporated, or aggregated, into higher level risk hierarchies, as exampled in FIG. 14. For example, multiple program management offices 220 (PMOs) may be organized under a higher organizational level, such as a program executive officer (PEO) 310. Similarly, a security requirement/policy associated with a higher level may affect a lower level. Alternatively, a higher level risk may not be permitted to affect a lower level risk assessment.

Similarly, a higher level hierarchy, which may include PEO 310, may be aggregated along with other PEOs in an organization, for example, the Navy or other armed service 405. The assessed risk of nodes in the higher level hierarchy may be based partly, or completely, on the assessed risks of nodes lower in the hierarchy. Alternatively, or in addition, assessed risks of nodes in hierarchies may be based upon the assessed risk of nodes on the same hierarchical level (for example, servers may inherit risks from other servers with which they interact), or further up in the hierarchy (for example, individual servers may inherit, for example, a security requirement/policy identified at the system level).

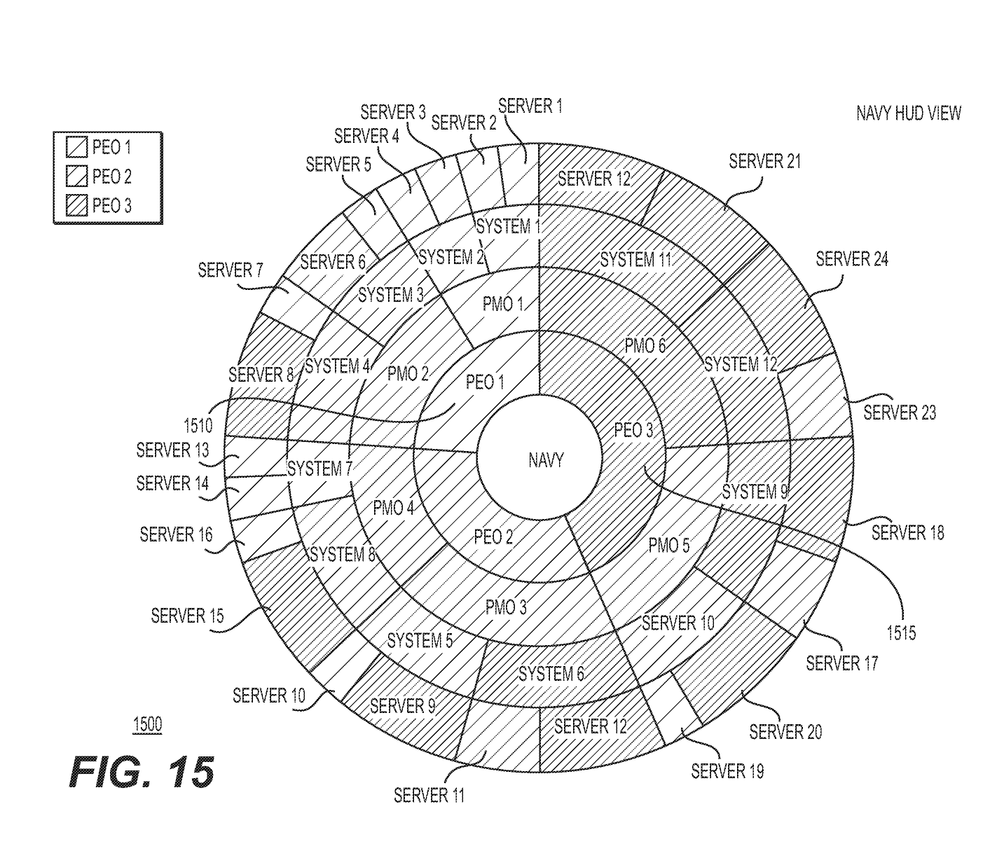

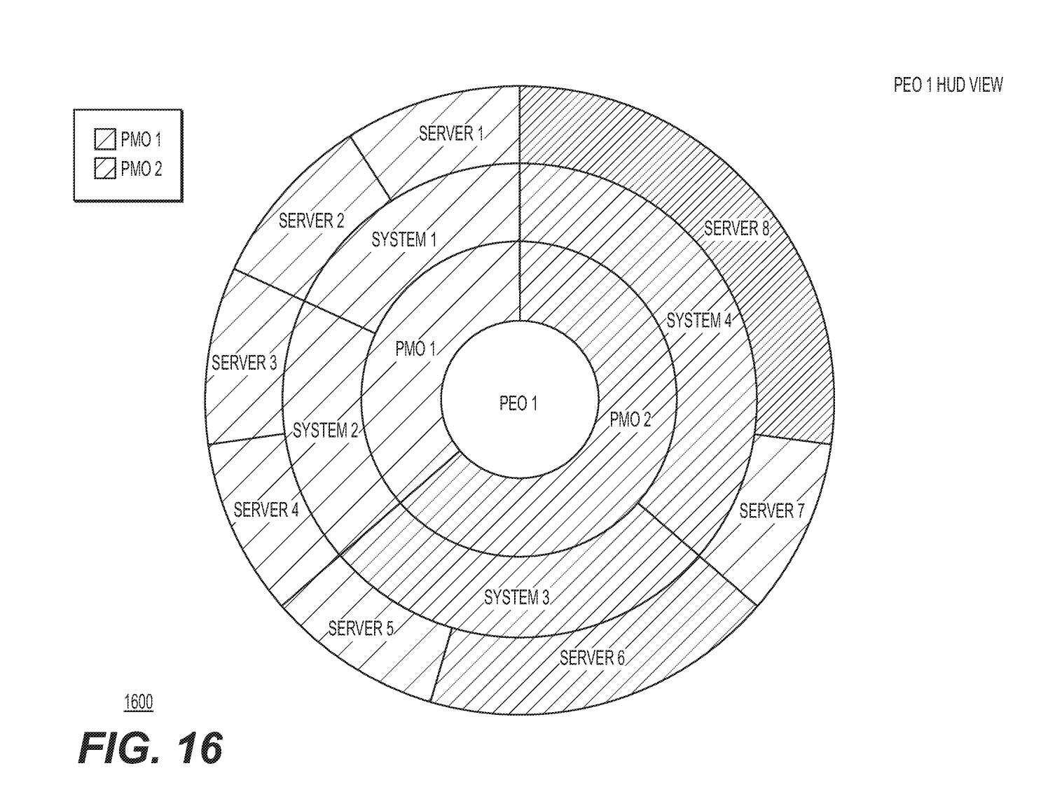

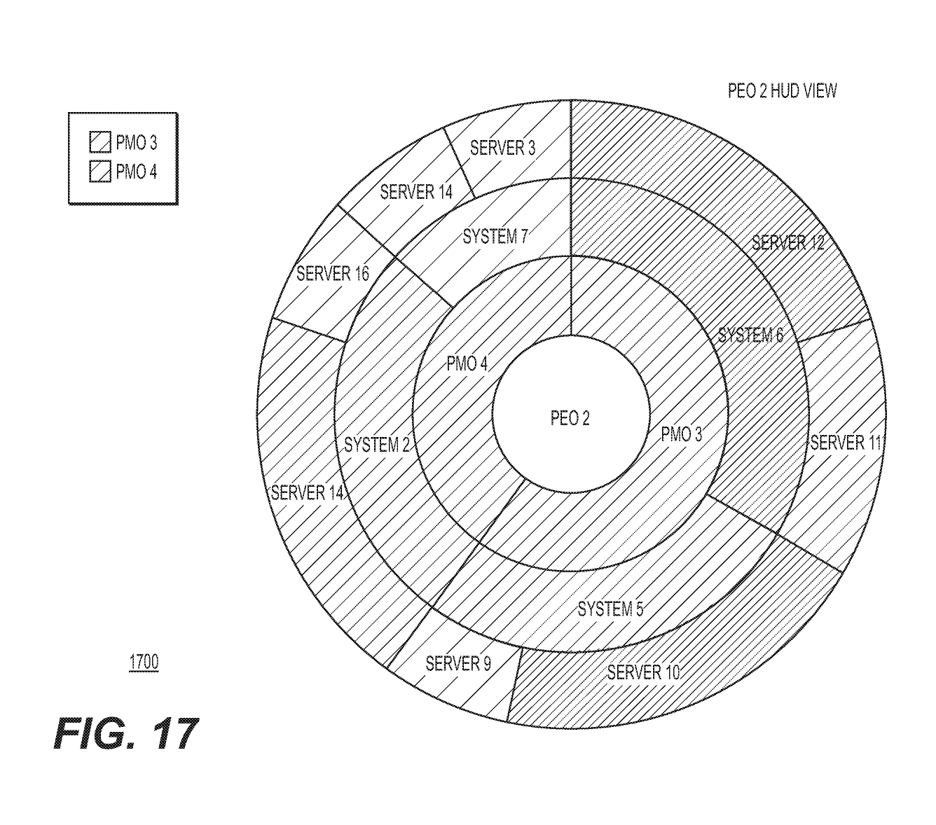

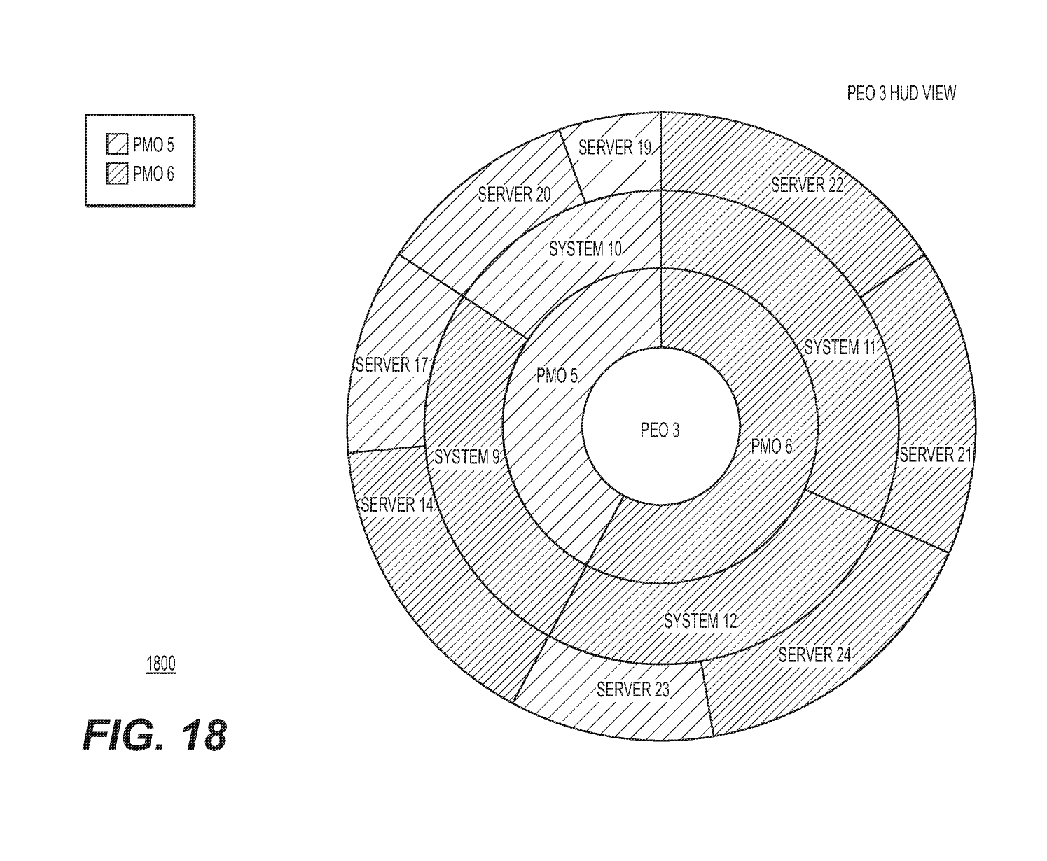

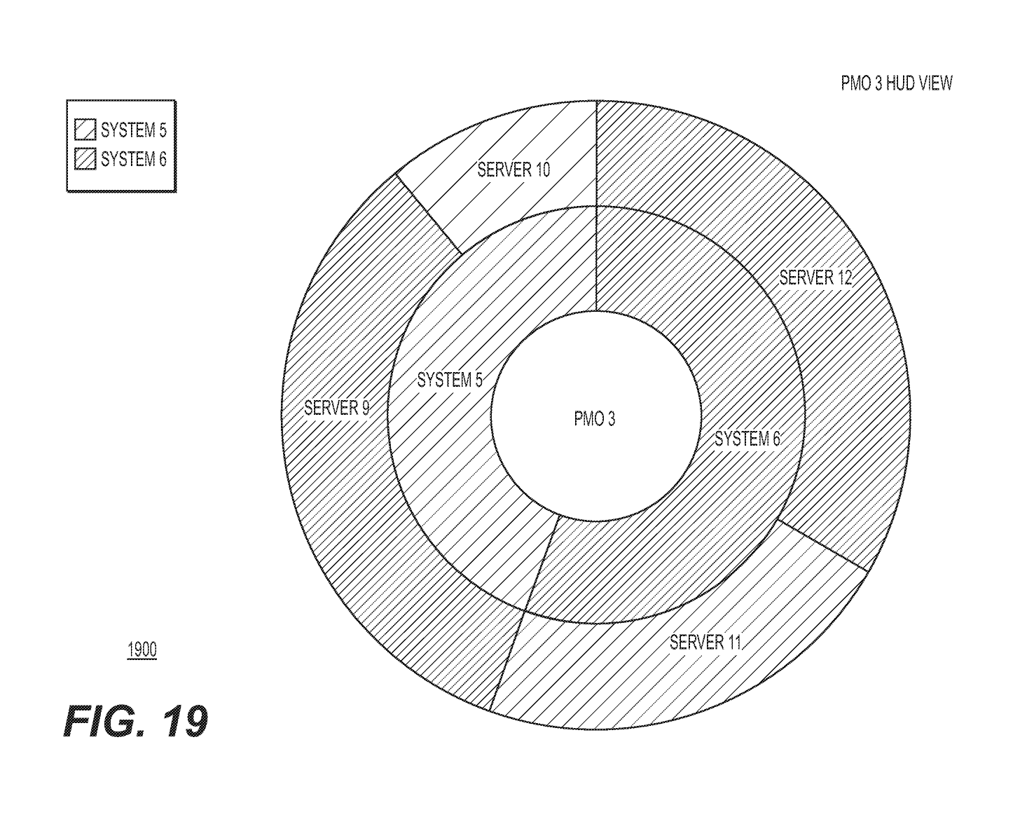

FIGS. 15-19 are example diagrams of aggregated server and/or system data at various organizational levels that may be displayed to one or more users, for example on a heads-up dashboard (HUD) display 1500. For example, a user may select a particular PEO level 1510, which may cause the system to display risk or other information associated with PEO 1510. Other levels of the organizational hierarchy may be depicted at the center of the display, such as of the organization, for example the Navy (FIG. 15), the PEO level (see FIGS. 16-18), the PMO level (see FIG. 19), etc.

Base risk determinations may be driven from the server level, with risk tiers such as 1 for low, 2 for medium, and 3 for high server risk, as discussed elsewhere herein. Upper hierarchical level results may be based on averages of the server scores that make up that particular level. In other words, the low-risk designation for PEO 1 at 1510 may be based upon the average score of the servers under PEO 1. Higher level risk designations may be averages of lower servers, or alternatively the median risk level of lower servers, the highest server risk level of any of the lower servers, the mode of the server risk level (most frequently occurring), etc.

The display 1500 may depict a fan chart with a series of concentric rings, where each concentric ring level represents a hierarchical level of the organization, with the highest selected level being displayed in the center or innermost ring. The display 1500 may automatically be updated based upon determined risk levels. For example, the color, pattern, size, and/or visual indicator assigned to the displayed servers, systems, higher level organizational elements, etc., may be based on the associated risk level. PEO 1510 may be designated as low risk, and a color such as the color green, and hence be displayed a different color than PEO 1515, which may be designated as high risk, for example the color red. Color coding has the effect of drawing the viewer's eyes where greater attention is warranted. Different risk levels may also be apportioned different sizes. For example, higher risk elements for a hierarchical ring may be given a larger, predetermined portion of the ring than lower risk elements, where the predetermined portion of the ring may also be determined based on the number of items in the ring. Overrides for higher risk from Overwatch Active escalations may be incorporated. For example, as days pass, unresolved risks may increase in assessed risk level according to predetermined rules, as discussed elsewhere herein.

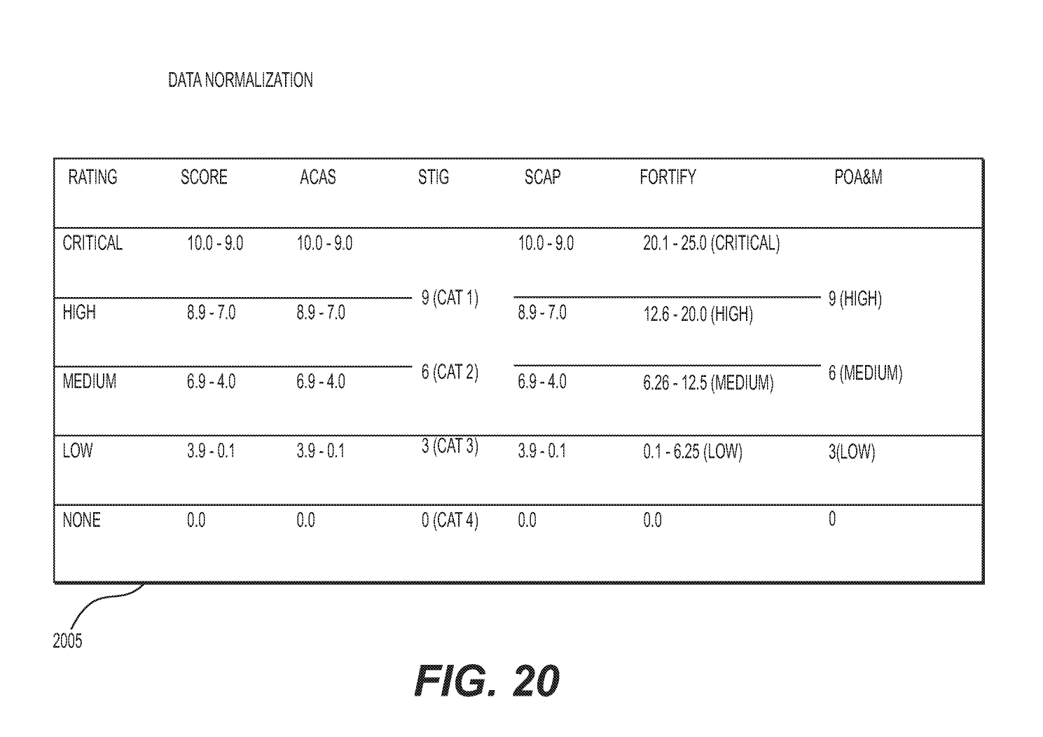

As shown in FIG. 20, risk data may be received from a plurality of data sources. For example, risk data may be received from ACAS, STIG, SCAP, Fortify, POA&M, etc. As shown in table 2005, risk data from one or more risk assessment data sources may be normalized to determine a composite risk score and/or risk rating.

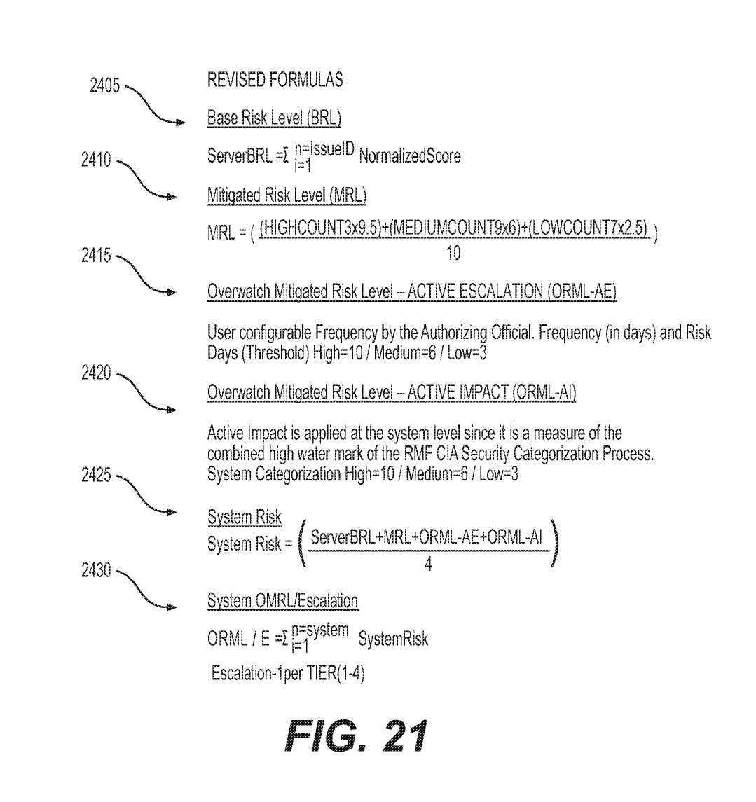

FIG. 21 is a listing of formulas that may be used to determine risk levels and/or scores discussed herein. As discussed above, a base score may be determined at step 2405 that may be an aggregated normalized score, such as a summation of a plurality of normalized scores. A mitigated risk level score may also be determined at step 2410. For example, system security metrics may be averaged to determine an overall mitigated risk level and/or mitigated risk level score. Confidentiality, integrity, and/or availability scores/multipliers may be used to determine the mitigated risk level. At step 2415, the risk level may be escalated by one or more authorized users by setting one or more threshold frequencies, as discussed elsewhere herein. At step 2420, an impact assessment may be determined, which may determine remediation priority, as discussed elsewhere herein. At step 2425, an overall system risk may be determined that may be based on the determined base level risk, mitigated risk level, escalation, and/or impact assessment. For example, one or more of these values may be averaged to determine the system level risk. At step 2430, the mitigated risk level may be divided by the escalation to determine how risk may escalate up the organizational hierarchy.

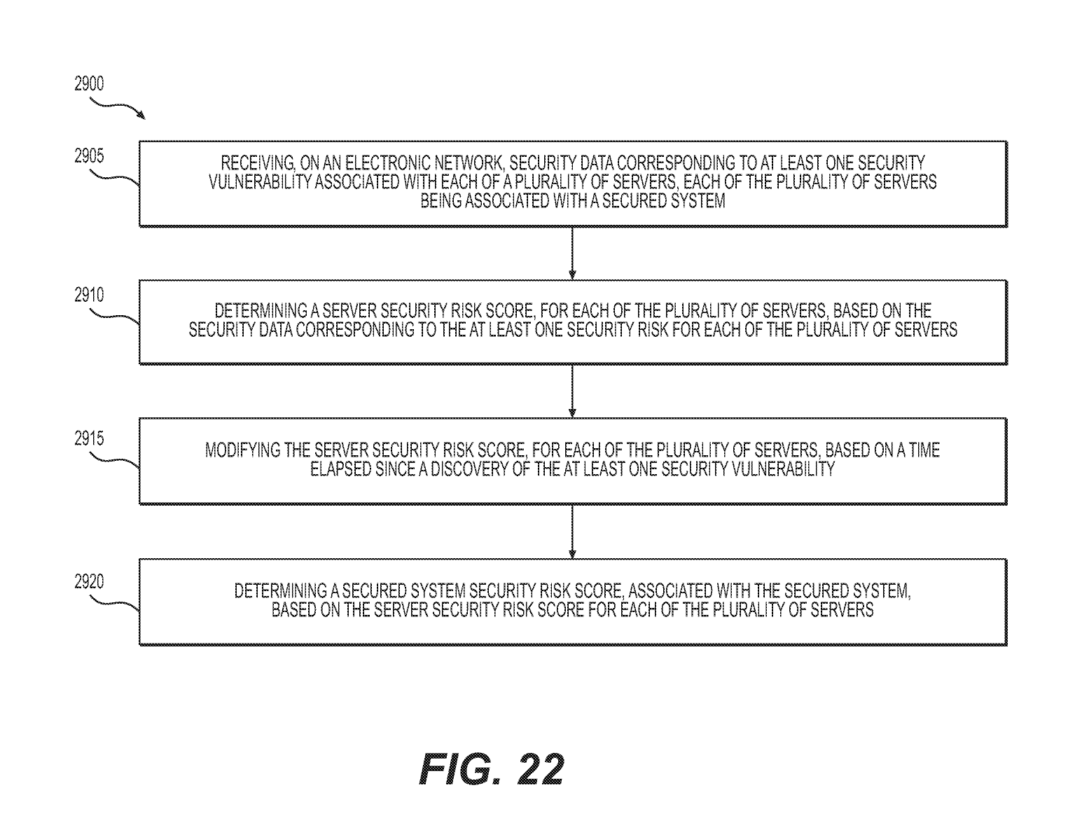

FIG. 22 is a flow diagram of a method 2900 for assessing risk, according to embodiments of the present disclosure. At step 2905, on an electronic network, security data may be received corresponding to at least one security vulnerability associated with each of a plurality of servers, each of the plurality of servers being associated with a secured system. At step 2910 a server security vulnerability score may be determined, for each of the plurality of servers, based on the security data corresponding to the at least one security vulnerability for each of the plurality of servers. At step 2915 the server security vulnerability score may be modified, for each of the plurality of servers, based on a time elapsed since a discovery of at least one security vulnerability. At step 2920, a secured system security vulnerability score may be determined, associated with the secured system, based on the server security vulnerability score for each of the plurality of servers.

Solutions presented herein resolve a number of problems presented by prior techniques. With prior techniques, it may be difficult to interpret security ratings and vulnerability reports, because various security solutions may use any number of incompatible methodologies and metrics. Techniques presented herein may normalize security ratings from various sources. Techniques presented herein may further combine a plurality of security ratings and metrics from various data sources to help produce an overall risk score for one or more servers, systems, devices, environments, etc. Further, security ratings of any hierarchical level of an organization may be based, at least in part, on security ratings of higher and/or lower levels. For example, a security rating of a system may be based, at least in part, on one or more security ratings of its constituent servers.

With prior techniques, identified security vulnerabilities may go unresolved for indefinite periods of time. Techniques presented herein may increment the risk assessment over time in a predetermined manner. Systems further up the organizational hierarchy may receive an increased risk score over time in a predetermined manner. In this way, threats may be escalated in a reliable fashion in order to more reliably ensure that security threats are removed and/or mitigated.

With prior techniques, it may be unclear how to combine information about various security risks to an organization. Techniques presented herein may apply multipliers and mitigators to increment and decrement a meta risk score for servers, systems, IoT devices, environments, other devices, etc., associated with an organization. Multipliers may be increased based upon the discovery dates of vulnerabilities, the lifespan of vulnerabilities, and/or remediation types and dates.

Further, prior techniques re-evaluate security assessments haphazardly.

Techniques presented herein may continuously and iteratively re-evaluate security risks, and update security risk status and/or accreditation in real time.

Further, prior techniques do not distinguish between risk scores and risk impacts. Techniques presented herein may allow for custom prioritization, for example, such that lower risk but higher impact security vulnerabilities may be given higher priority than higher risk but lower impact security vulnerabilities. Techniques presented herein also allow for vulnerabilities to be mitigated, and for risk scores to be reflective of mitigation steps. For these reasons and others discussed herein, techniques presented herein demonstrate a variety of improvements to the technical field.

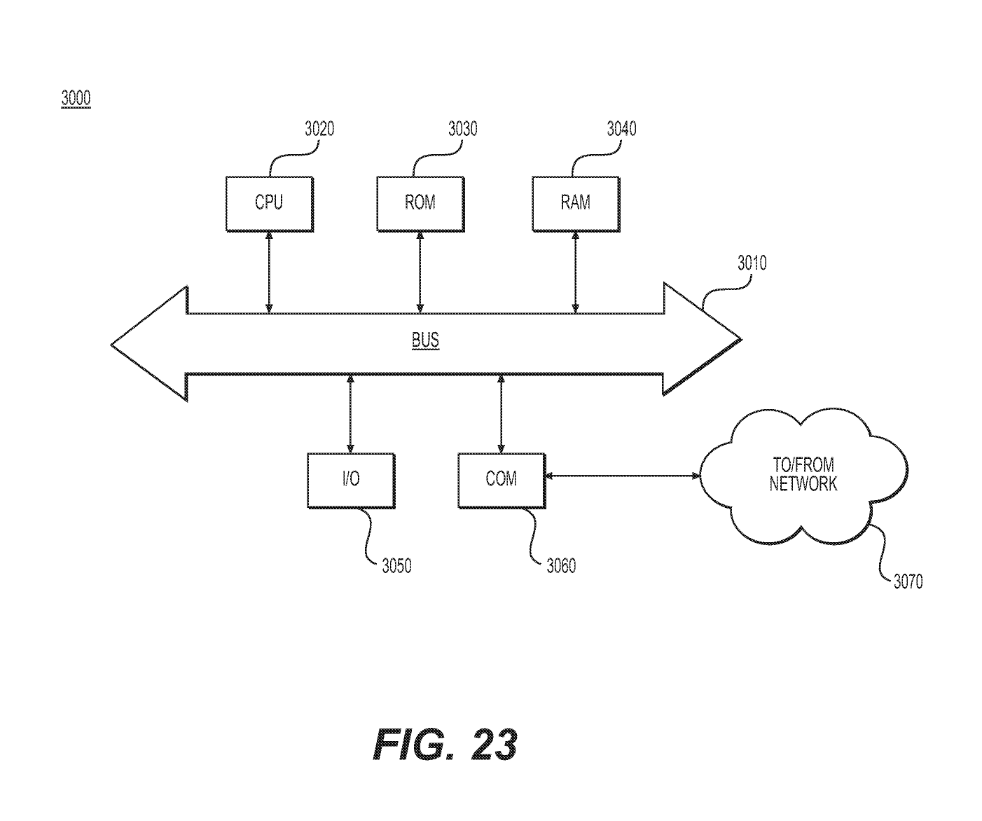

FIG. 23 is a simplified functional block diagram of a computer that may be configured as a client, agent, or server for executing the method of FIG. 22, according to exemplary an embodiment of the present disclosure.

Specifically, in one embodiment, as shown in FIG. 23, any computer and/or server may be an assembly of hardware 3000 including, for example, a data communication interface 3060 for packet data communication. The platform may also include a central processing unit (“CPU”) 3020, in the form of one or more processors, for executing program instructions. The platform typically includes an internal communication bus 3010, program storage, and data storage for various data files to be processed and/or communicated by the platform such as ROM 3030 and RAM 3040, although the system 3000 often receives programming and data via network communications 3070. The server 3000 also may include input and output ports 3050 to connect with input and output devices such as keyboards, mice, touchscreens, monitors, displays, etc. Of course, the various server functions may be implemented in a distributed fashion on a number of similar platforms, to distribute the processing load. Alternatively, the servers may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the presently disclosed sharing application, methods, devices, and systems are described with exemplary reference to mobile applications and to transmitting HTTP data, it should be appreciated that the presently disclosed embodiments may be applicable to any environment, such as a desktop or laptop computer, an automobile entertainment system, a home entertainment system, etc. Also, the presently disclosed embodiments may be applicable to any type of Internet protocol that is equivalent or successor to HTTP, such as HTTPS.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for determining a secured system security risk score, the method comprising:
receiving, on an electronic network, security data corresponding to a security vulnerability of each of a plurality of servers, each of the plurality of servers being associated with a secured system;
determining a server security risk score, for each of the plurality of servers, based on the security data corresponding to the security risk for each of the plurality of servers;
modifying the server security risk score, for each of the plurality of servers, based on a time elapsed since a discovery of each security vulnerability; and
determining a secured system security risk score, associated with the secured system, based on the server security risk score for each of the plurality of servers.

2. The method of claim 1, wherein modifying the server security risk score further comprises:
determining a level of server hosting environment protections according to predetermined criteria; and
modifying the server security risk score, for each of the plurality of servers, based on the determined level of server hosting environment protections.

3. The method of claim 1, further comprising:
determining a system categorization of the secured system; and
modifying the secured system security risk score based upon the system categorization.

4. The method of claim 1, further comprising:
determining a security impact for the secured system; and
determining a mitigation and/or remediation priority for the secured system based upon each associated server risk score and the security impact.

5. The method of claim 1, further comprising:
determining that a predetermined security time period has elapsed without security risk mitigation and/or remediation for a first server of the plurality of servers; and
modifying the server security risk score, for the first server, based on determining that the predetermined security time period has elapsed without security risk mitigation and/or remediation.

6. The method of claim 1, further comprising:
determining that a predetermined security time period has elapsed without security data for a first server of the plurality of servers; and
modifying the server security risk score, for the first server, based on determining that the predetermined security time period has elapsed without security data.

7. The method of claim 1, wherein the secured system is associated with an organization, and further comprising:
determining a second secured system security risk score; and
determining an organization risk score, associated with the organization, based on the determined secured system security risk score and second secured system security risk score.

8. The method of claim 1, further comprising:
displaying indicators corresponding to the secured system, secured system security risk score, plurality of servers, and server security risk score for each of the plurality of servers, on a graphic comprising a plurality of concentric circles.

9. A system for determining a secured system security risk score, the system comprising:
a data storage device storing instructions for determining a secured system security risk score; and
a processor configured to execute the instructions to perform a method comprising:
receiving, on an electronic network, security data corresponding to a security risk of each of a plurality of servers, each of the plurality of servers being associated with a secured system;
determining a server security risk score, for each of the plurality of servers, based on the security data corresponding to the security risk for each of the plurality of servers;
modifying the server security risk score, for each of the plurality of servers, based on a time elapsed since a discovery of each security risk; and
determining a secured system security risk score, associated with the secured system, based on the server security risk score for each of the plurality of servers.

10. The system of claim 9, wherein modifying the server security risk score further comprises:
determining a level of server hosting environment protections according to predetermined criteria; and
modifying the server security risk score, for each of the plurality of servers, based on the determined level of server hosting environment protections.

11. The system of claim 9, the method further comprising: determining a system categorization of the secured system; and modifying the secured system security risk score based upon the system categorization.

12. The system of claim 9, the method further comprising:
determining a security impact for the secured system; and
determining a mitigation and/or remediation priority for the secured system based upon each associated server risk score and the security impact.

13. The system of claim 9, the method further comprising:
determining that a predetermined security time period has elapsed without security risk mitigation and/or remediation for a first server of the plurality of servers; and
modifying the server security risk score, for the first server, based on determining that the predetermined security time period has elapsed without security risk mitigation and/or remediation.

14. The system of claim 9, wherein the secured system is associated with an organization, and the method further comprising:
determining a second secured system security risk score; and
determining an organization risk score, associated with the organization, based on the determined secured system security risk score and second secured system security risk score.

15. The system of claim 9, the method further comprising:
displaying indicators corresponding to the secured system, secured system security risk score, plurality of servers, and server security risk score for each of the plurality of servers, on a graphic comprising a plurality of concentric circles.

16. A non-transitory computer-readable medium storing instructions that, when executed by a processor, cause the processor to perform a method for determining a secured system security risk score, the method comprising:
receiving, on an electronic network, security data corresponding to a security risk of each of a plurality of servers, each of the plurality of servers being associated with a secured system;
determining a server security risk score, for each of the plurality of servers, based on the security data corresponding to the security risk for each of the plurality of servers;
modifying the server security risk score, for each of the plurality of servers, based on a time elapsed since a discovery of each security risk; and
determining a secured system security risk score, associated with the secured system, based on the server security risk score for each of the plurality of servers.

17. The non-transitory computer-readable medium of claim 16, wherein modifying the server security risk score further comprises:
determining a level of server hosting environment protections according to predetermined criteria; and
modifying the server security risk score, for each of the plurality of servers, based on the determined level of server hosting environment protections.

18. The non-transitory computer-readable medium of claim 16, the method further comprising:
determining a system categorization of the secured system; and
modifying the secured system security risk score based upon the system categorization.

19. The non-transitory computer-readable medium of claim 16, the method further comprising:
determining a security impact for the secured system; and
determining a mitigation and/or remediation priority for the secured system based upon each associated server risk score and the security impact.

20. The non-transitory computer-readable medium of claim 16, the method further comprising:
determining that a predetermined security time period has elapsed without security risk mitigation and/or remediation for a first server of the plurality of servers; and
modifying the server security risk score, for the first server, based on determining that the predetermined security time period has elapsed without security risk mitigation and/or remediation.
